(19) United States
(12) Patent Application Publication
(10) Pub. No.: US 2010/0210200 A1
(43) Pub. Date: Aug. 19, 2010

(54) COIN MECHANISM

(75) Inventors: Malcolm Bell, Leeds (GB); Graham Jones, Lancashire (GB); Nicholas Aspinall, Lancashire (GB); Robert Blythin, Lancashire (GB)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Money Controls Limited, Oldham, Lancashire (GB)

(21) Appl. No.: 12/676,545

(22) PCT Filed: Aug. 29, 2008
(86) PCT No.: PCT/EP2008/061415

§ 371 Date: Mar. 4, 2010

(30) Foreign Application Priority Data
Sep. 6, 2007 (GB) 0717312.3

(51) Int. Cl. G07D 9/00; G07D 5/00; G07D 1/00; B65D 83/08

(52) U.S. Cl. 453/3; 453/44; 194/302; 221/121

(57) ABSTRACT

A coin mechanism comprises a coin entry point (2) to receive coins (1), a coin exit point (19), a coin acceptor (5) having an inlet (7) for coins to be tested, a sensor and processing arrangement configured determine the acceptability of coins under test that enter the inlet, an coin accept path (10) for acceptable coins and a non-accept path (12) for non-acceptable coins. A first coin conveyor runs along first coin feed path (6) from a coin receiving portion that receives coins from coin entry path (3) to deliver coins in succession to the inlet (7) of the coin acceptor. A second coin conveyor runs along a second coin feed path (17) from a coin receiving portion that receives coins from the non-accept path of the acceptor to the coin, to deliver coins to the coin exit point.

### FIELD OF THE INVENTION

This invention relates to a coin mechanism which has particular but not exclusive application to vending machines.

### BACKGROUND OF THE INVENTION

It is well known that multi-denomination coin acceptors are used in vending machines to authenticate coins of different denominations, so as to direct acceptable coins to an accept path and non-acceptable coins to a non-accept path for return to the user. A sorter may be used to sort the accepted coins according to their denomination, so as to feed them to individual hoppers that can be used to dispense change to a purchaser. For example, when the purchaser presents one or more coins to the acceptor and the item to be purchased is of a lesser monetary value, one or more of the hoppers may be instructed to pay out change of a monetary value corresponding to the difference between the purchase price and the monetary sum for the or each coin presented by the purchaser.

There are types of hoppers for providing a coin payout. For example, our EP 0080842A discloses a hopper suitable for use with an individual denomination of coin that utilises a selectively drivable endless conveyer to elevate coins from a coin receiving portion of the conveyor along an ascending portion to an exit on the ascending portion of the conveyor for payout.

Coin hoppers are also known that comprise an inclined circular disc that includes radially disposed holes to receive coins from a container for payout. Upon rotation of a disc, coins fall into the holes and are dispensed individually. Reference is directed to our EP-A-026602.

### SUMMARY OF THE INVENTION

According to the invention in a first aspect, there is provided a coin mechanism comprising an endless loop conveyor whose path includes a coin receiving portion, an ascending portion that ascends from the coin receiving portion, a descending portion that descends to the coin receiving portion and an overarching portion that extends from the ascending portion to the descending portion, a coin supply configured to supply coins individually onto the conveyor in the coin receiving portion to be conveyed along the ascending portion to the overarching portion, a guide on the underside of the overarching portion to retain the coins on the conveyor, and a coin exit to permit coins to leave the conveyor at a location thereon beyond the ascending portion.

The location of the exit may be on the underside of the overarching portion. Thus, the location of the exit is not restricted to the ascending portion of the conveyer.

In another aspect, the invention provides a coin mechanism comprising an endless loop conveyor whose path includes a coin receiving portion, an ascending portion that ascends from the coin receiving portion, a coin supply configured to supply coins individually onto the conveyor in the coin receiving portion to be conveyed along the ascending portion, and a coin exit to permit coins to leave the conveyor from a location above the coin receiving portion wherein the conveyor includes a plurality of upstanding members to define receptacles to receive individual coins to be conveyed from the coin receiving portion to the exit, the upstanding members being configured so that the receptacles can receive coins of different diameters with their peripheries disposed inwardly of both longitudinal side edges of the conveyor.

The upstanding members may be configured so that the receptacles can receive coins of different diameters with their centres aligned in the direction of travel of the conveyer. The conveyor may comprise a plurality of segments with an individual one of the receptacles on each of the segments.

The upstanding members may be configured to provide only two points of contact with the side edge of a coin aligned with one of its major faces on the conveyor. In one example, the upstanding members comprise a pair of upstanding pips each for engaging the side edge of a coin on the conveyor. Alternatively, the upstanding members may comprise a pair of converging ledges each for engaging the side edge of a coin on the conveyor. These ledges or pips need not be disposed symmetrically on the conveyor.

Thus, the conveyor may be used to process coins of different denominations.

In a further aspect of the invention there is provided a coin mechanism comprising a coin acceptor having a coin inlet to receive a coin and authentication circuitry configured to determine the coin's authenticity, an accept path and a non-accept path, the acceptor being configured to direct the coin to the accept path if determined by the authentication circuitry to be acceptable or to the non-accept path if not accepted, a reject path for rejected coins, a recycle path configured to return non-accepted coins from the non-accept path to the inlet of the acceptor for re-authentication, and a recycle gate operable to direct non-accepted coins selectively to the recycle path for re-authentication by the acceptor, or to the reject path.

Thus, if a coin is rejected, it can be re-presented for authentication by the acceptor.

A controller may be provided to control operation of the recycle gate to control the number of times that a non-accepted coin is returned via the recycle path to be authenticated by the acceptor before being directed to the reject path.

The invention also includes a coin mechanism comprising: a coin entry point to receive coins; a coin exit point; a coin acceptor having an inlet for coins to be tested, a sensor and processing arrangement configured determine the acceptability of coins under test that enter the inlet, an coin accept path for acceptable coins and a non-accept path for non-acceptable coins; a first coin conveyor that runs along first coin feed path from a coin receiving portion to deliver coins in succession to the inlet of the coin acceptor; a coin entry path extending from the coin entry point to the coin receiving portion of the first conveyor; and a second coin conveyor that runs along a second coin feed path from a coin receiving portion that receives coins from the non-accept path of the acceptor to the coin, to deliver coins to the coin exit point.

A drive motor configuration may be provided to drive the first conveyor at a faster rate when no coins are exiting the first conveyor into the inlet of the acceptor, than when coins are exiting the conveyor into the inlet.

The first conveyor may include a plurality of conveyor segments each configured to convey a single coin from said coin receiving portion of the first path to the inlet of the acceptor.

The second conveyor may include a plurality of segments each configured to convey a plurality of coins from the coin receiving portion of the second conveyor to be delivered to the coin exit point.

A coin return path may be included for returning coins from the coin entry point to the coin exit point without passage along the first coin feed path, together with a coin diverter device for diverting coins to pass along the coin return path when said first conveyor is not operational.

Sensors may be provided for sensing the passage of coins through the mechanism, and a processor responsive to the timing of the passage of a coin past the sensors can be used to detect a coin jam. A jam release motor operable by the processor can then release the coin from the mechanism in the event of a detected coin jam.

The coin acceptor may include a coin rundown path defined between a main body of the acceptor and a door, in which case the jam release motor can be configured to open the door in the event of a coin jam on the rundown path and release the coin from the acceptor.

The invention also includes an improved arrangement to eject coins from a conveyor segment when more than one coin becomes lodges in the coin receptacle. According to the invention there is provided a conveyor for a coin mechanism including at least one conveyor segment, side walls between which in use said conveyor segment moves longitudinally, a coin ejection outlet in one of said side walls, a coin receptacle on the segment to receive a coin, the receptacle including upstanding members disposed asymmetrically of the longitudinal centreline of the segment such at when two coins are received in coin receptacle one of them is ejected through the coin ejection outlet upon movement of the receptacle past the outlet, and the other of them remains in the receptacle.

The upstanding members include a pair of upstanding, converging ledges each for engaging the side edge of a coin lying with one of its major faces on the segment, with the converging ledges being asymmetrical and converging at a joining point to one side of the longitudinal centreline of the conveyor.

### BRIEF DESCRIPTION OF THE DRAWINGS

In order that the invention may be more fully understood an embodiment thereof will now be described by way of illustrative example with reference to the accompanying drawings, in which:

FIG. 1 is a schematic block diagram of a coin mechanism in accordance with the invention;

FIG. 2 is a perspective view of the mechanism from one side;

FIG. 3 is a perspective view of the mechanism from the other side;

FIG. 4 is a partially broken away enlarged perspective view of a first coin feed path shown in FIGS. 1 to 3;

FIG. 5 is an enlarged view of a portion X of the first coin feed path shown in FIG. 4;

FIG. 6 is a more detailed view of the recycle gate illustrated in FIG. 1 in a reject position for directing coins to the reject path;

FIG. 7 illustrates a recycle gate in a recycle position to direct coins to the recycle path;

FIGS. 8 and 9 are plan and side views of a segment for use in one or more of the conveyors;

FIGS. 10 and 11 are plan and side views of four of the segments interconnected to form a portion of the conveyor;

FIGS. 12 and 13 illustrate plan and side views of an alternative version of a segment for the conveyor, utilising a receptacle in the form of a chevron.

FIG. 14 is an enlarged, schematic sectional view of the coin entry and exit points shown in FIG. 1;

FIG. 15 is a more detailed view of a coin jam release arrangement for the coin acceptor shown in FIG. 1;

FIG. 16 is a schematic sectional view of the acceptor shown in FIG. 15 taken along the line A-A′

FIGS. 17 and 18 are plan a side views of a modified version of the conveyor illustrated in FIGS. 10 and 11 in which only alternate segments have coin receptacles,

FIGS. 19 and 20 are side and plan views of an alternative form of conveyor segment with a coin receptacles defined by asymmetrical chevrons, and

FIGS. 21A-C illustrate successive stages in a process to eject more than one coin from the coin receptacle of the conveyor segment shown in FIGS. 19 and 20.

### DETAILED DESCRIPTION

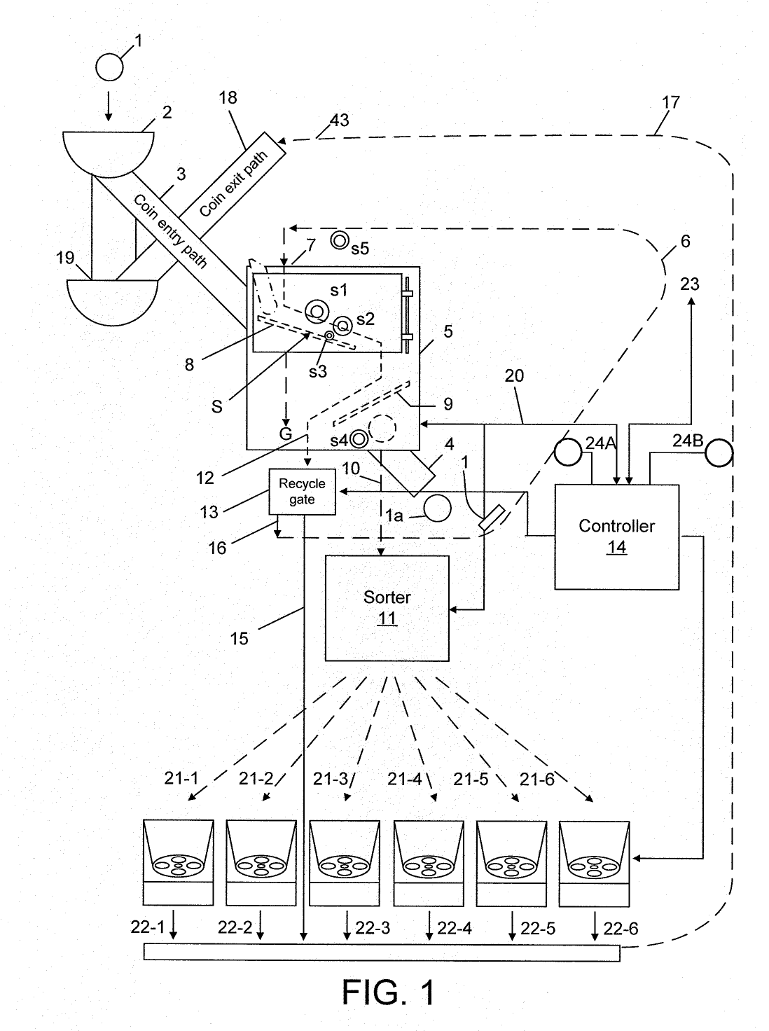

The coin mechanism illustrated in FIGS. 1 to 3 is for use in vending applications to authenticate coins of different denominations of a multi-coin currency set when a purchaser presents coins to the mechanism to carry out a purchasing transaction. The term “coin” as used herein includes not only coins issued by government organisations and institutions but also tokens, for example as used in casinos, and other coin like items with an attributable value. The coins are sorted according to denomination and if required, change is given to the purchaser, corresponding to the difference between a purchase price and the value of one or more coins offered by the purchaser to make the purchase.

The functionality of the coin mechanism is illustrated in broad outline in FIG. 1. To perform a purchasing transaction, a user presents a coin 1 under test to a coin entry point 2 comprising a cup-shaped receptacle, and the coin slides down a chute 3 to a chute outlet 4, past (but not through) a multi-denomination coin acceptor 5, onto a first coin feed path 6 at a location beneath the acceptor 5. The first coin feed path 6 is defined by a first endless loop conveyor to be described in more detail hereafter, having a path of travel partially shown in dotted outline in FIG. 1. Thus coins, fed successively into the coin entry point 2 feed edgewise down the chute to leave the chute outlet 4, as indicated by coin 1a, and fall onto the conveyor moving along the first coin feed path 6.

In practice, the user may deposit a plurality of coins in the coin entry receptacle 2 contemporaneously, which may arrive at the coin feed path from the outlet 4 either together or rapidly one after the other. As explained in more detail later, the conveyor moving along path 6 is configured to separate these bunched coins into an ordered, single file row along the conveyor such that each coin is spaced from the preceding coin, with one of its major surfaces lying on the conveyor. As explained in more detail later, the conveyor carries the coins in succession upwardly to the coin inlet 7 of the coin acceptor 5, where the coins fall in an orderly succession into the acceptor to be authenticated, so that each coin in the succession can be reliably tested by the acceptor 5.

One example of a multi-denomination coin acceptor is described in EP-A-1560168. The acceptor 5 includes a coin rundown path 8 along which coins under test from the first coin feed path 6 run edgewise through a sensing station S that includes sensors S1, S2, S3, which may comprise inductive and/or optical sensors to determine conductive/optical characteristics of a coin under test. As well known in the art, the signals developed by the coin in the sensors S1, S2, S3 are compared using an internal microprocessor with stored values corresponding to acceptable coins of various denominations. If the coin under test is determined to be acceptable, a solenoid operated gate 9 is opened to allow the coin to pass along a coin accept path 10 to a sorter 11 to be sorted according to denomination. A credit sensor S4 may be used to check that the accepted coin has passed into the accept path to permit credit corresponding to the accepted coin to be attributed to it. If the coin is not authenticated as a true coin of one of the denominations under test, it is passed along a non-accept path 12 towards a solenoid operated recycle gate 13 which is operated under the control of a controller 14. The non-accepted coin can be directed by the recycle gate 13 either to a reject path 15 or to a recycle path 16.

When the coin is directed to the reject path 15 it is returned to the user. To this end, a second coin feed path 17 is provided, defined by a second endless loop conveyor to be described in more detail hereafter, having a path of travel partially shown in dotted outline in FIG. 1. The second conveyor transports the rejected coin along the second coin feed path 17 to a coin exit chute 18 that leads to a coin exit point adjacent the coin entry point 2, comprising a cup shaped receptacle 19 from which coins can be taken by the user.

Alternatively, the recycle gate 13 may direct the non-acceptable coin to the coin recycle path 16, to be fed to the first coin feed path 6 and returned to the inlet 7 of the acceptor 5, so as to make a second attempt to authenticate the coin under test. Non-acceptable coins may pass more than once along the recycle path 16 and the first coin feed path under the control of controller 14, which operates the recycle gate 13.

The acceptor 5 provides electrical signals on line 20 indicating the acceptability of individual coins under test. This data is fed to the controller 14, which permits the controller to control operation of the recycle gate 13 for coins indicated to be non-acceptable by the acceptor 5. The data on line 20 also indicates the denomination of acceptable coins tested in the acceptor 5.

Coins deemed to be true coins of acceptable denominations are fed to the sorter 11 on accept path 10 and are sorted according to their individual denominations. The sorting may be carried out on the basis of different sizes of coins of different denominations but the sorter may also include electrical gates operated as a function of the data fed thereto on line 20. The sorted coins are by the sorter 11 along a separate sorter exit paths 21-1 . . . 21-6 to individual rotary hoppers 22-1 . . . 22-6 such each hopper receives true coins of an individual denomination. The individual hoppers may comprise devices as described in detail in our EP-A-0266021. The hoppers 22 are operable under the control of controller 14 to pay out a predetermined number of coins of individual denominations to provide change to purchaser when required. Coins paid out as change are fed along the second coin feed path 17 into the chute 18 to be delivered to the coin exit point 19.

In use, the controller 14 receives data on input line 23 corresponding to the value of an intended purchase. The purchaser then inserts one or more coins 1 into the coin entry point 2 which are fed onto the first coin feed path 6 and are authenticated by the acceptor 5. Non-acceptable coins are passed to the non-accept path 12 and the non-acceptability of the coin is signalled on signal line 20 to the controller 14. On a first occurrence of non-acceptability, the controller 14 may operate the recycle gate 13 to direct the non-acceptable coin along the recycle path 16 to be fed along the first coin feed path 6 to re-inserted into the inlet 7 of the acceptor 5. If, upon the second authentication attempt, the coin is still determined to be non-acceptable, the controller 14 may then operate the recycle gate 13 to direct the coin to the reject path 15, so as to be returned to the purchaser at the coin exit point 19, via the second coin feed path. It will be appreciated that a non-acceptable coin may pass along the recycle path 16 to the first coin feed path 6 for recycling through the acceptor 5 one or several times depending on the routine performed by the controller 14.

However, if the coin is deemed acceptable by the acceptor 5, it is passed along the coin accept path 10 to sorter 11. Data corresponding to the denomination of the acceptable coin is fed on line 20 to the controller 14 to permit the controller to calculate whether change is required. Data corresponding to the coin denomination is also fed to the sorter 11, if the sorter includes one or more solenoid operated gates, to direct the coin to the appropriate sorter exit path 21-1 . . . 21-6 depending on its denomination.

In the event that change needs to be given, the controller 14 instructs one or more of the coin hoppers 22-1 . . . 22-6 to dispense one or more coins into the second coin feed path 17, for return to the coin exit point 19, thereby delivering the change to the user. Thus the controller 14 compares the total value of the coins offered by the purchaser that were found acceptable by the acceptor 5, with the purchase price indicated on line 23, computes the difference, and instructs the hoppers 22 to pay out one or more coins of the different denominations held in the hoppers into the second coin feed path 17, to provide change of a value corresponding to the difference.

The driving of the endless conveyors that extend along the first and second coin feed paths 6, 17 is performed by electric motors 24A, 24B controlled individually by the controller 14. The motors 24A, 24B are actuated by the controller 14 in response to an input thereto on line 23, indicating that a transaction is being initiated. The motors 24A, 24B are controlled by the controller 14 to run for a predetermined time following no activity sensed by the controller from the line 23.

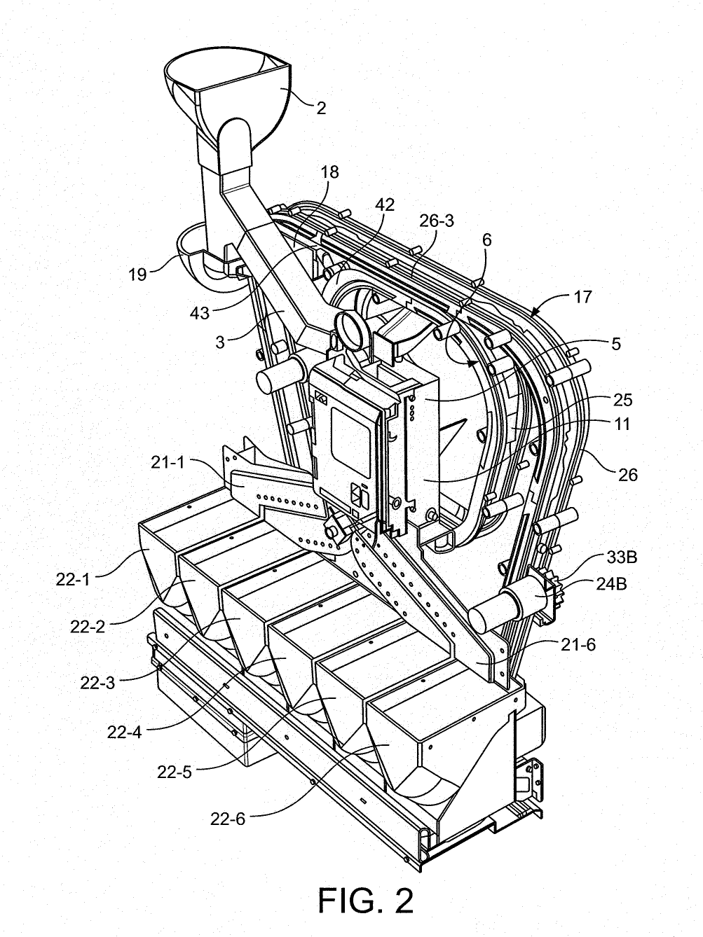

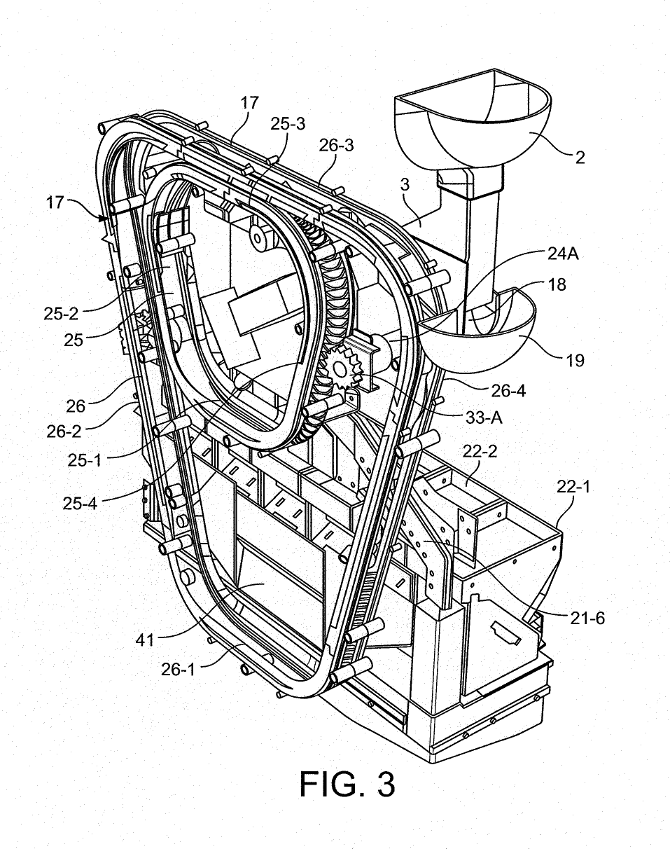

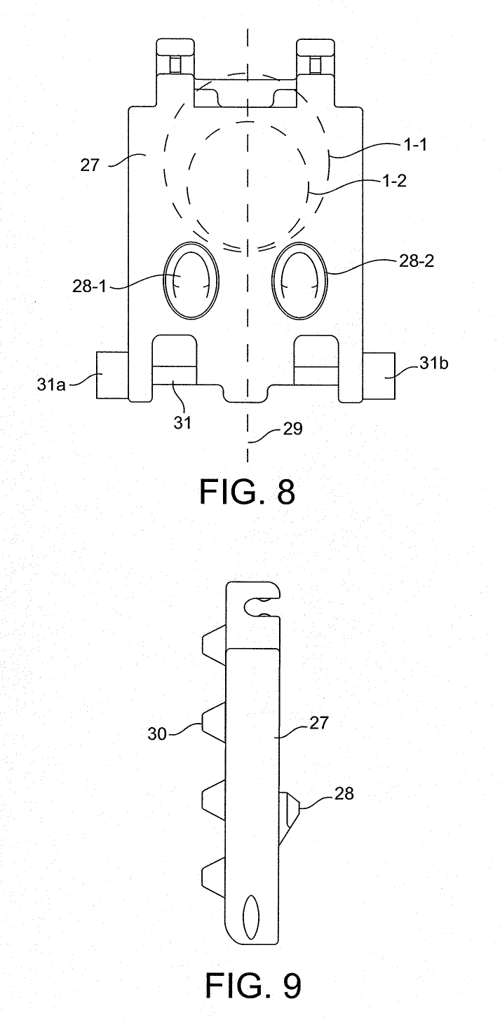

FIGS. 2 and 3 illustrate the physical configuration of the coin mechanism shown in FIG. 1 in more detail. As shown more clearly in FIGS. 2 and 3, the first coin feed path 6 and the second coin feed path 17 each comprise an individual endless loop conveyor 25, 26. Each of the conveyors is formed of a plurality of pivoted segments 27 illustrated in more detail in FIGS. 8-11. The segments 27 are configured to define individual receptacles for a coin to be transported. In the embodiment illustrated in FIGS. 8 and 9, the receptacles are defined by upstanding members in the form of pips 28-1, 28-2 on the front face of the segment 27, which are so configured that the receptacle can receive coins of different diameters. As illustrated in FIG. 8, the receptacle can receive a coin 1-1 of relatively large diameter as illustrated in dotted outline or coin 1-2 of smaller diameter. In both situations, the coin is located between the pips 28-1, 28-2, to be disposed with their centres aligned with longitudinal centreline 29 of the conveyor, which corresponds to the direction of travel of the conveyer. Thus, the coins are held in a position spaced from the edges of the conveyor, which avoids jamming. The members 28-1, 28-2 are upstanding by an amount that captures only one coin in the receptacle between them, so that when a number of coins arrive concurrently from the chute 3 onto the conveyor extending along the first coin feed path 6, the coins will be singulated such that individual ones of the coins are received in successive ones of the of the receptacles defined by the upstanding members 28 of successive segments 27 of the conveyor. If more than one coin overlies a particular receptacle, the overlying coin will slide over the upstanding members 28 of the receptacle that already contains a coin, into a following receptacle on another segment 27 of the conveyor, as the conveyor moves along the path 6.

Thus, in use, the conveyor acts as a coin singulator whereby only an individual coin lies with one of its major surfaces on the conveyor to be supported at only two points on its circumference by the upstanding members 28-1, 28-2.

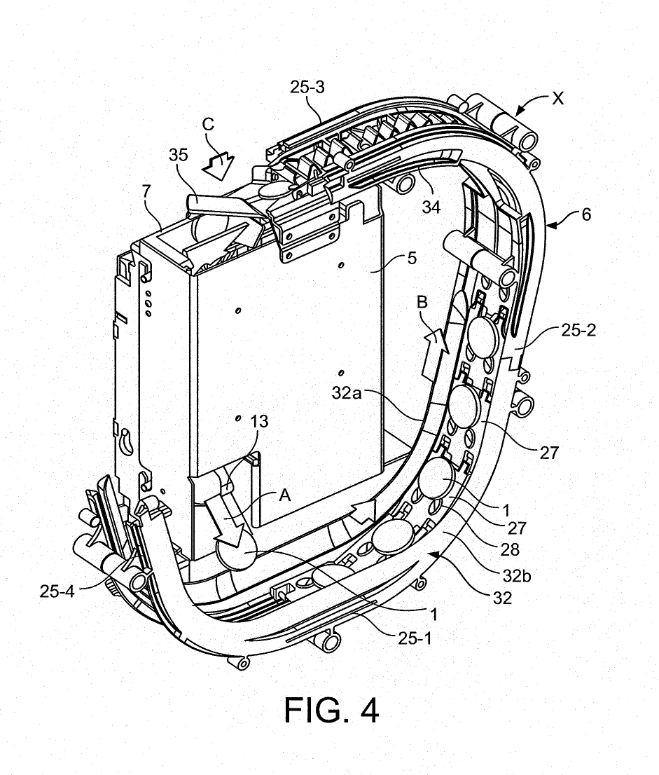

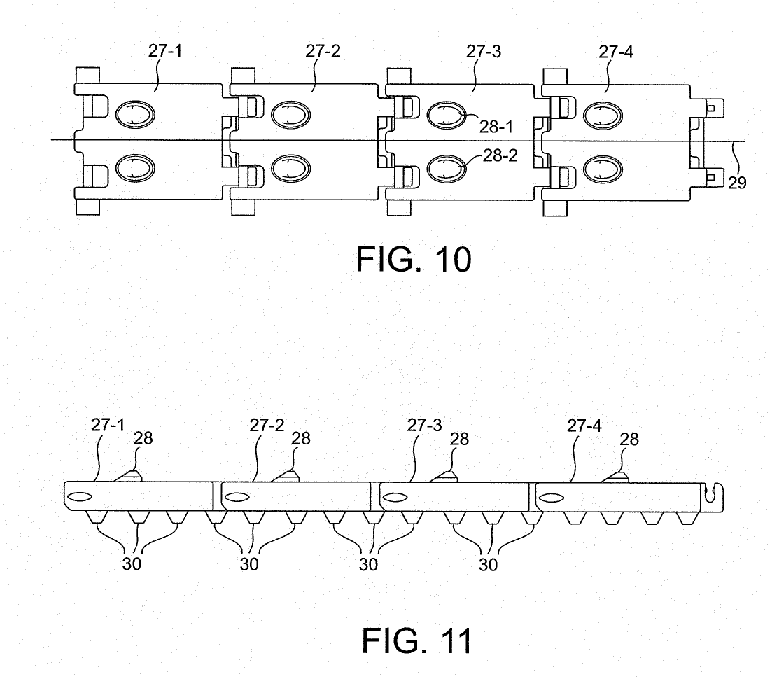

The other, rear face of the conveyor is provided with teeth 30 for engaging with a driven pinion for driving the conveyor. As shown in FIG. 10, the individual conveyor segments are pivotally connected by transverse pins 31 that have protruding ends 31a, 31b which act as guide wheels. Referring again to FIG. 4, the guide wheels are received in a conveyor guide frame 32 which has re-entrant side portions 32a, 32b that act as guide rails for the guide wheels 31a, 31b of the conveyor segments 27.

As illustrated in FIG. 4, the conveyor 25 for the first coin feed path 6 includes a lowermost, coin receiving portion 25-1 that receives coins from the coin sorter 5 under the control of the recycle gate 11. Coin 1 is illustrated emerging from the recycle gate 13 in a direction of arrow A so as to be received in one of the receptacles on segment 27 of the conveyor 25 in the coin receiving portion 25-1.

The conveyor extends from the coin receiving portion 25-1 to an inclined, ascending portion 25-2 along which coins are lifted in the direction of arrow B. Referring again to FIGS. 2 and 3, an overarching portion 25-3 of the conveyor extends generally horizontally, from the ascending portion 25-2 to a descending portion 25-4 that extends back to the coin receiving portion 25-1. The teeth 30 of the conveyor segments 27 engage with a pinion 33A driven by the electric motor 24A under the control of controller 14.

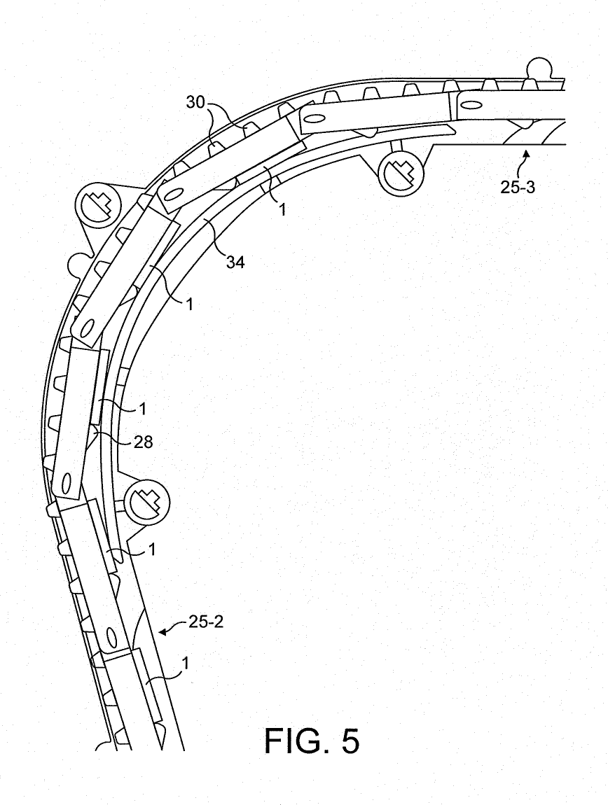

FIG. 5 illustrates the manner in which coins on the conveyor 25 turn the corner from the ascending portion 25-2, to the overarching portion 25-3. A guide 34 is disposed on the underside of the conveyor so as to retain the coins 1 in the receptacles defined by pips 28 as the conveyor segments 27 progressively turn so as to extend in the generally horizontal direction of the overarching portion 25-3, with the coin receptacles 28 on the underside of the conveyor 21. As shown in FIG. 4, the guide 34 extends along the underside of the overarching portion 25-3 to an exit point 35 which comprises a downwardly extending chute that extends from the underside of the conveyor to allow coins to drop out of the receptacles 28 in the direction of arrow C so as to slide back into the coin inlet 7 of the coin acceptor 5.

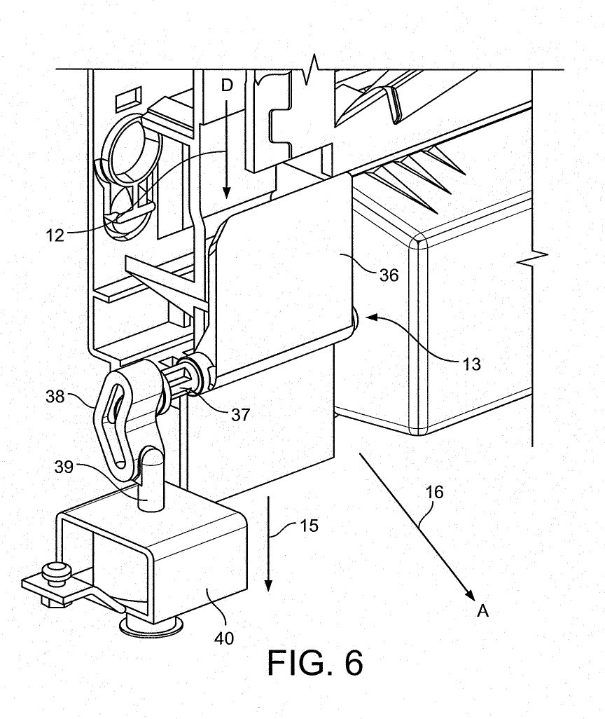

FIG. 6 illustrates the recycle gate 13 of FIG. 1 in more detail. As previously explained, non-acceptable coins pass along the non-accept path 12 illustrated by arrow D in FIG. 6. The recycle gate 13 comprises a flap 36 mounted on shaft 37 having a cam 38 at one end that can be driven by the actuator 39 of solenoid 40 that is controlled by the controller 14 shown in FIG. 1. FIG. 6 illustrates the reject gate 13 when positioned to direct the coins to the reject path 15, which extends vertically downwardly beneath the coin acceptor 5.

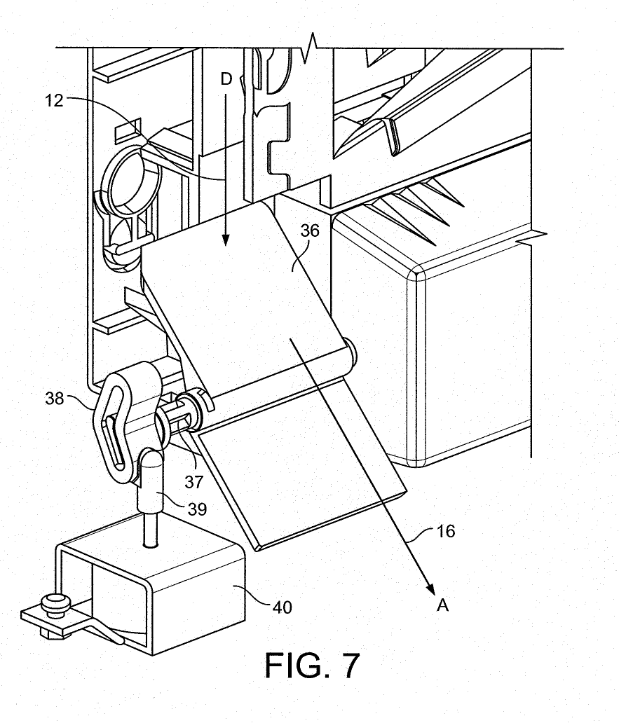

When the controller 14 operates the solenoid 40, the flap 36 is rotated to the position shown in FIG. 7. The actuator 39 engages cam 38 to rotate the shaft 37 so as to move the flap 36 into the path 12 and thereby deflect coins from the non-accept path into the recycle path 16 that extends in the direction of allow A, which, as shown in FIG. 4, extends to the coin receiving portion 25-1 of the conveyor 25 that provides the first coin feed path 6.

The conveyor 26 that provides the second coin path 17 is of a similar construction to the conveyor 25, with a coin receiving portion 26-1 illustrated in FIG. 3 that receives coins through a chute 41 that in turn receives dispensed coins from the hoppers 22-1 . . . 22-6 as illustrated in FIG. 1. Referring again to FIG. 3, the coin receiving portion 26-1 extends into an inclined, ascending portion 26-2 and then to an overarching portion 26-3 and a descending portion 26-4. The overarching portion 26-3 has a guide 42 on its underside in the same manner as the conveyor 25 to retain coins in the receptacles when on the underside of the conveyor in the overarching portion. The guide extends to coin exit 43 which permits the coins to drop out of the receptacles 24 on the underside of the conveyor in the overarching portion so as to enter the coin exit chute 18 shown in FIG. 1 and slide under the effect of gravity to the exit point 19. The conveyor 26 is driven by electric motor 24B that drives a pinion 33B which engages with the teeth 30 on the segments 27 of the conveyor. The motor 24B is controlled by controller 14 shown in FIG. 1.

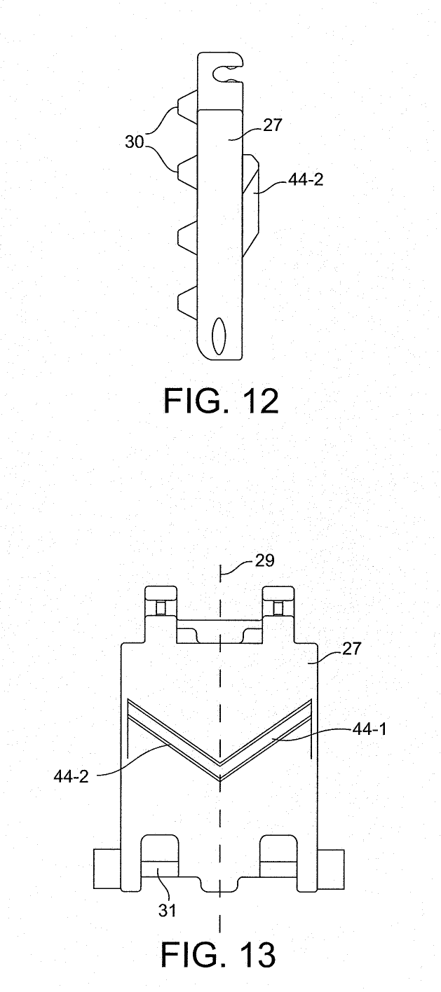

An alternative design of receptacle on segment 27 is illustrated in FIGS. 12 and 13. In this arrangement, receptacle is defined by upstanding members 44-1, 44-2 that comprise a generally V-shaped configuration of ledges, with the centre of the V being aligned with the longitudinal centre line 29 of the conveyor. The ledges 44 engage an individual coin 1 at two circumferential points only and constrain it so that when received in the receptacle with one of its major surfaces on the segment 27, it is constrained so that its centre is aligned with the longitudinal centreline 29 of the conveyor notwithstanding differences in coin diameter, for example with coins of different denominations.

### Coin Entry Control

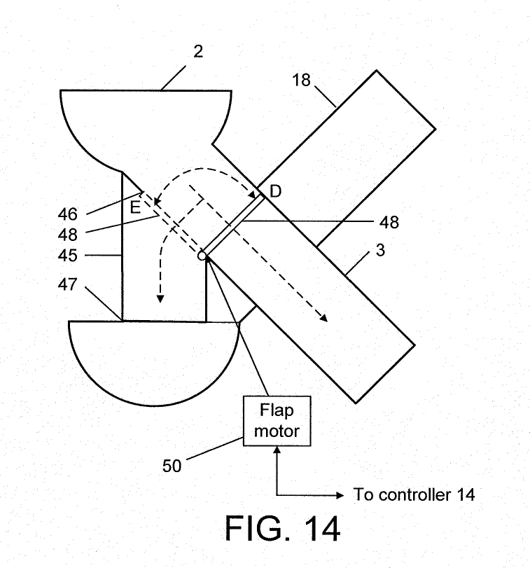

The apparatus is configured to prevent items being spuriously inserted into the coin entry point 2 and causing a jam. For example, children may insert items into the coin entry point 2, which either may jam in the coin rundown path 8 of the coin acceptor 5 or may pass onto the conveyor 25 on the first coin feed path 6, when stationary, and jam the conveyor. FIG. 14 illustrates the coin entry and exit points 2, 19 shown in FIG. 1 in more detail together with their associated coin entry and exit chutes 3, 18. A coin return chute 45 extends between the coin entry point 2 and the coin exit point 19 to return items placed in the coin entry point 2 to the coin exit point when the apparatus is not ready to receive coins. The return chute 45 has a return chute opening 46 and a return chute exit 47 to deliver coins from the coin entry point 3 to the coin exit point 19. A flap 48 is rotatably mounted on a shaft 49 driven by a motor 50 under the control of the controller 14. The flap 48 can be moved between a first, coin return position D shown in solid outline where it blocks the passage of coins down the entry chute 3 and reveals the coin return chute opening 46, a second, coin accept position E shown in dotted outline in which the coin entry chute 3 is unblocked and the return chute opening 46 is closed.

The controller 14 operates the motor 50 so that the flap 48 is only moved to the second, coin accept position when the apparatus is operative, for example when the controller 14 receives an input signal on line 23 indicating that a purchasing transaction is being initiated. At other times, the flap 48 is maintained in the first position so that unwanted items inserted into the coin entry point are returned through the coin return chute 45 directly to the coin exit point 19 without entering the coin acceptor 5.

### Coin Jam Release

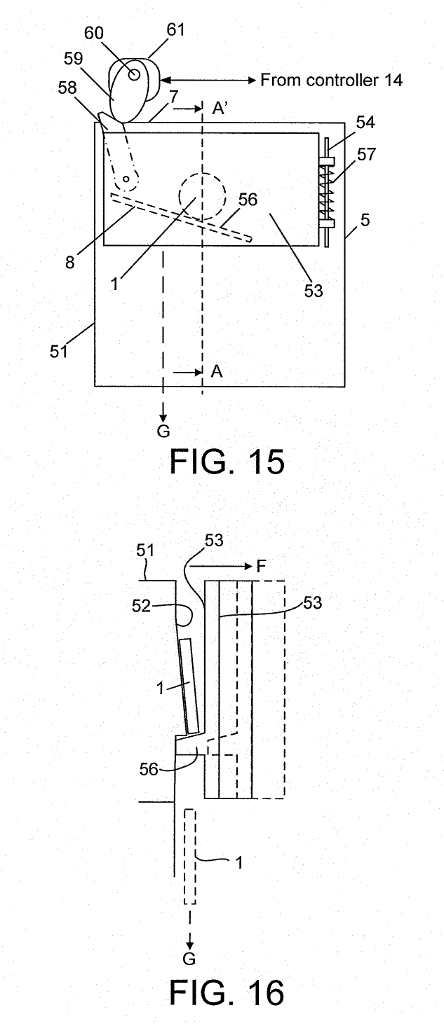

The apparatus is also configured to release a coin passing through the acceptor 5 in the event of a coin becoming jammed on the coin rundown path 8 or other sensed conditions that may lead to a coin jam. As shown particularly in FIGS. 15 and 16, the coin acceptor 5 comprises a main body 51 with an inclined sidewall 52 bounded by a hinged door 53 that turn on a shaft 54 that defines a hinge axis. The door 53 has an interior sidewall 55 with an inclined lip 56 facing the sidewall 52 of the main body. The coin rundown path 8 is defined by the facing side walls 52, 55 and the lip 56, such that the coin 1 under test rolls edgewise along the lip past the sensor coins S1, S2, S3 shown in FIG. 1, which may be mounted in the main body 51 or the door 53 or both.

The door is normally held in a closed position as shown in solid outline in FIG. 16, by means of a spring 57 on the shaft 54 shown in FIG. 15, thereby providing the coin rundown path 8. However, in the event of a coin jam on the coin rundown path, the door can be opened by means of a pivoted lever 58, which can be turned anticlockwise as shown in FIG. 15 against the force of a spring (not shown). The lever 58 acts a wedge between the door 53 and the main body 51, and progressively opens the door when turned anticlockwise, such that the door 53 opens in the direction of arrow F in FIG. 16 and assumes the position shown in dotted outline. In this configuration, the coin 1 is no longer held on the coin rundown path and can fall downwardly along a release path in the direction of arrow G. In this way, a coin jammed on the coin rundown path is released from the acceptor 5 as illustrated by coin 1 shown in dotted outline in FIG. 16. Referring to FIG. 1, the path G passes outside of the recycle gate 13 directly to the second coin feed path 17, so that the released coin on path G is returned to the coin exit point 19 by the conveyor 25.

The door opening lever 58 is operated by a rotary cam 59 mounted on shaft 60 driven by a cam motor 61 under the control of the controller 14. In order to detect a jam, the controller 14 performs a routine that determines the timing for the coin being detected by some or all of the sensors S1, S2, S3 and/or S4 and S5. When a coin passes correctly through the acceptor, the time taken for a coin to pass from one sensor to another will fall within a normal timing range. The controller 14 determines if the timing moves outside of this normal timing range since this signifies a jam, and if a jam is thereby detected, the controller 14 actuates the cam motor 61 to open the door 53 and release the coin into release path G.

It will be appreciated that this jam release approach need not only be used for the coin path through the coin acceptor 5 but could be used on other parts of the paths that coins follow through the device, wherein parts of the paths may be provided with motor operated doors, flaps or the like which allow coins which may be jammed or giving rise to a potential jam, to be ejected from the coin path and returned to the exit point 19. The doors, flaps or the like may be opened selectively when sensors along the coin path indicate the a coin is not moving along the path with the usually expected timing past the sensors.

### Change Giving

As explained above, when a handful of coins are placed in the cup shaped coin entry point 2 to make a purchase, they slide down the coin entry chute 3 onto the first coin feed path, where they become lodged in individual segments of the conveyor 25 so as to be fed one-by-one in succession to the inlet 7 of the acceptor 5. Assuming that the coins are accepted, change may then be dispensed by the hoppers 22 in order to complete the purchasing transaction. The change is conveyed by the conveyor 26 along the second coin feed path 17 to the coin exit point to be retrieved by the purchaser. The use of the conveyors 25, 26 introduces a delay into the delivery of change to the purchaser after they have inserted coins into the coin entry point 2 to make the purchase.

In order to reduce this delay, at start-up, the conveyor 25 is driven at high speed by the motor 23, at a rate that can be faster than the rate at which coins can be discriminated and accepted by the acceptor 5 e.g. twice the acceptance speed. An initialisation sensor S5 is disposed adjacent the conveyor 25 at the coin inlet 7 of the acceptor 5. When coins are inserted by the purchaser, the conveyor 25 initially contains no coins but as they are fed along the path 6 towards the inlet 7, the first coin will reach the initialisation sensor S5, which will signal to the controller 14 that coins are about to enter the acceptor. The controller 14 then instructs the motor 23 to run at a slower rate, so that the successive following coins on the conveyor are fed into the acceptor at a rate at which the acceptor can reliably accept true coins and reject frauds.

If under certain circumstances, coins are fed along the path 6 so that some of the conveyor segments 25 are empty of coins, the output of sensor S5 can be utilised by the controller 14 to speed up the conveyor 25 during the gaps in the coin feed into the inlet 7.

Also, the configuration of the conveyor 26 on the second coin feed path 17 can be modified in order to speed up the delivery of change to the coin exit point 19. As described above the segments of conveyor 26 are configured to convey single coins in a similar manner to the conveyor 25. However, for the second coin feed path 17, the segments of the conveyor 26 can be configured to convey multiple coins, in which case the protrusions 28 shown in FIGS. 8 and 9 and the chevrons 44 shown in FIGS. 12 and 13 may be made taller so that coin receptacle on each segment of the conveyor 26 can carry multiple coins e.g. four coins. The conveyor 26 in one example is run at ten segments per second.

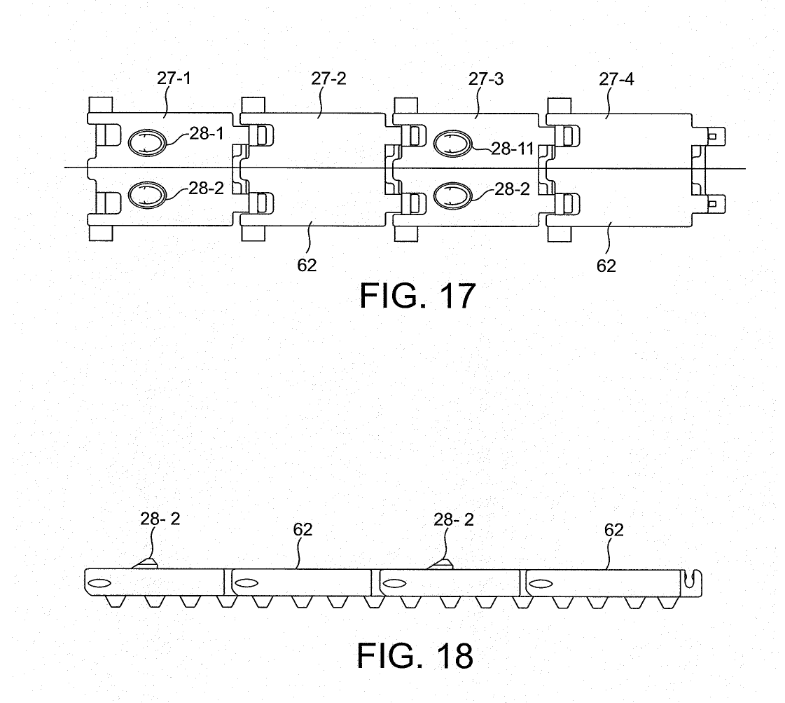

Another modified version of the conveyor is shown in FIGS. 17 and 18, which correspond to FIGS. 10 and 11 but in which the pips 28-1, 28-2 are provided only on alternate segments 27-1, 27-3. The intermediate segments 27-2 and 27-4 have plane surfaces 62 which provide a space for the ordered entry of individual coins into the receptacles of the segments 27-1 and 27-3. This can assist in obtaining an ordered supply of coins on the conveyor when large batches of coins are fed into the coin entry point which might otherwise result in incoherent bunching of coins on the conveyor.

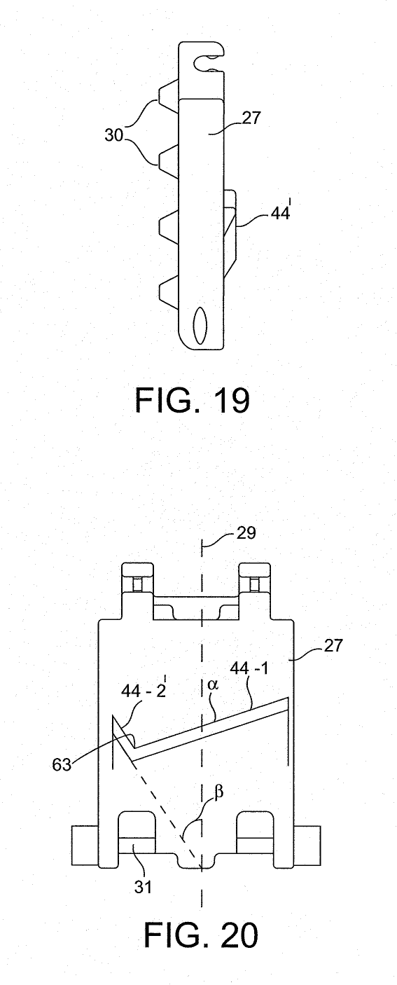

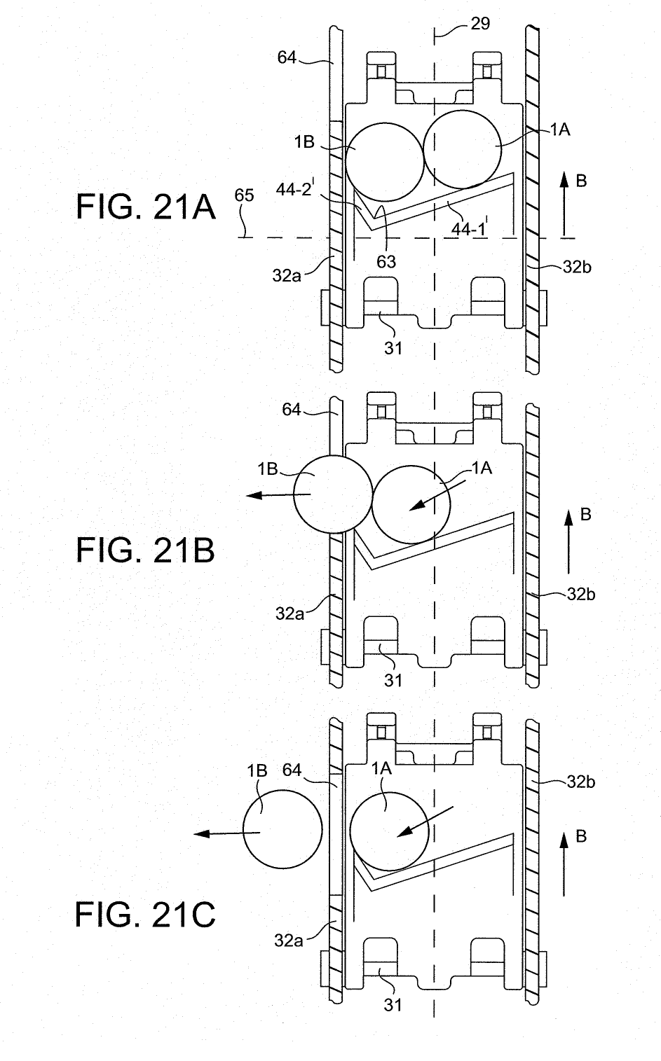

Another modified conveyor segment is illustrated in FIGS. 19 and 20, which corresponds the segment of FIGS. 12 and 13 but in which the arms of the chevron 44′ are disposed asymmetrically of the conveyor centreline 29. The chevron 44′ comprises a first relatively long arm 44-1′ and a second relatively short arm 44-2′ which are joined at a point 63 to one side of the conveyor centreline 29 to provide the coin receptacle, and which subtend a relatively large angle α and small angle β with the centreline 29 respectively. The segment 27 of FIGS. 19 and 20 can eject a coin from the receptacle when more than one small coin becomes spuriously located in the receptacle, as will now be described in more detail with reference to FIG. 21.

In FIG. 21A, one of the segments 27 of a conveyor made up of multiple segments as shown in FIGS. 19 and 20, moves forward in the direction of arrow B between side walls 32a, 32b. The side wall 32a includes a coin ejection opening 64. Two small coins 1A, 1B have spuriously entered the coin receptacle provided by the chevron 44′.

As the conveyor moves in the direction of arrow B, a reaction force occurs between the coin 1A and the long arm 44-1′ of the chevron and a similar reaction force occurs between the second coin 1B and the short arm 44-2′ of the chevron. These reaction forces act in direction that tends to urge the coins towards the meeting point 63 of the arms of the chevron 44′. However, due to the difference between the relatively large angle α and small angle β subtended by the chevron arms 44-1′, 44-2′ when these reaction forces are resolved in a direction 65 transverse to the direction of travel B of the conveyor, the force acting on the coin 1A is greater than that acting on coin 1B in the direction 65, so that there is a net resultant force which urges both coins in the transverse direction 65 towards the side wall 32a.

As the conveyor moves to the position shown in FIG. 21B, the coin 1B becomes aligned with the opening 64 in the side wall 32a, so that coin 1B is no longer constrained within the coin receptacle on the conveyor. Consequently, coin 1B is ejected by the aforesaid net resultant force from the coin receptacle, leaving only the coin 1A in the receptacle, as shown in FIG. 21C. The coin 1A is prevented from ejection through the opening 64 by the short arm 44-2′ of the chevron. The coin 1B ejected from the conveyor can then fall back to the coin receiving portion of the conveyor to be reloaded thereon. It will be appreciated that the ejection principle described by way of example with reference to FIG. 21 can be achieved with other coin receptacle designs than the described asymmetrical chevron arrangement. For example, asymmetric and longitudinally spaced pips or other arrangements of upstanding members on the conveyor segment can be used.

The entire apparatus shown in FIGS. 2 and 3 may be mounted in a rectangular casing, for example to be used at a checkout in a supermarket.

Many modifications and variations of the described examples of the invention are possible within the scope of the appended claims.

1. A coin mechanism comprising:
a coin acceptor configured to authenticate and to sort coins received in a coin entry point;
an endless loop conveyor whose path includes a coin receiving portion, an ascending portion that ascends from the coin receiving portion, a descending portion that descends to the coin receiving portion and an overarching portion that extends from the ascending portion to the descending portion;
a coin supply configured to supply coins sorted by the coin acceptor individually onto the conveyor in the coin receiving portion to be conveyed along the ascending portion to the overarching portion;
a guide on the underside of the overarching portion to retain the coins on the conveyor; and
a coin exit to permit coins to leave the conveyor at a location thereon beyond the ascending portion to be dispensed at a coin exit point.

2. A coin mechanism according to claim 1 wherein said location is on the underside of the overarching portion.

3. A coin mechanism according to claim 1 wherein the conveyor includes a plurality of upstanding members to define receptacles to receive individual coins to be conveyed from the coin receiving portion to the exit.

4. A coin mechanism according to claim 3 wherein the upstanding members are configured so that the receptacles can receive coins of different diameters with their peripheries disposed inwardly of both longitudinal side edges of the conveyor.

5. (canceled)

6. A coin mechanism according to claim 4 wherein the upstanding members for configured so that the receptacles can receive coins of different diameters with their centres aligned in the direction of travel of the conveyor.

7. A coin mechanism according to claim 3, wherein the conveyor includes a plurality of segments with an individual one of the receptacles being provided on at least some of the segments.

8. A coin mechanism according to claim 7 wherein the receptacles are provided on each of the segments.

9. A coin mechanism according to claim 7 wherein the receptacles are provided on alternate ones of the segments.

10. A coin mechanism according to claim 3 wherein the upstanding members are configured to provide only two points of contact with the side edge of a coin lying with one of its major faces on the conveyor.

11. A coin mechanism according to claim 3 wherein the upstanding members include a pair of upstanding pips each configured to engage the side edge of a coin lying with one of its major faces on the conveyor.

12. A coin mechanism according to claim 3 wherein the upstanding members include a pair of upstanding, converging ledges each configured to engage the side edge of a coin lying with one of its major faces on the conveyor.

13. A coin mechanism according to claim 12 wherein the converging ledges are symmetrical and converge at a joining point aligned with the longitudinal centreline of the conveyor.

14. A coin mechanism according to claim 12 wherein the converging ledges are asymmetrical and converge at a joining point to one side of the longitudinal centreline of the conveyor.

15. A coin mechanism according to claim 14 including side walls on opposite sides of the conveyor, and a coin ejection opening in one of the side walls configured so that when more than one coin is received in the receptacle, one of them is ejected through the opening.

16. A coin mechanism comprising:
a coin acceptor having a coin inlet to receive a coin and authentication circuitry configured to determine the coin's authenticity;
an accept path and a non-accept path, the acceptor being configured to direct the coin to the accept path if determined by the authentication circuitry to be acceptable or to the non-accept path if not accepted,
a reject path for rejected coins
a recycle path configured to return non-accepted coins from the non-accept path to the inlet of the acceptor for re-authentication, and
a recycle gate operable to direct non-accepted coins selectively to the recycle path for re-authentication by the acceptor, or to the reject path.

17. A coin mechanism according to claim 16 including control means to control operation of the recycle gate to control the number of times that a non-accepted coin is returned via the recycle path to be authenticated by the acceptor before being directed to the reject path.

18. A coin mechanism according to claim 16 including, to convey coins from the recycle path to the acceptor, an endless loop conveyor whose path includes a coin receiving portion to receive coins directed thereto by the recycle gate, an ascending portion that ascends from the coin receiving portion to convey coins therefrom and a coin exit at location above the coin receiving portion to direct coins from the conveyor back to the coin inlet of the acceptor.

19. A coin mechanism according to claim 16, wherein the acceptor is operable to discriminate between coins of different denomination, and including a plurality of hoppers to receive coins of different individual denominations accepted by the acceptor, and a coin sorter to direct the coins of different denominations to the hoppers from the acceptor.

20. A coin mechanism according to claim 16, wherein the hoppers are operable to dispense coins of different denominations to provide change, and including a change exit point and a change giving conveyor to convey coins dispensed by the hoppers to the change exit point.

21. A coin mechanism according to claim 20, wherein the change giving conveyor comprises an endless loop conveyor whose path includes a coin receiving portion configured to receive coins dispensed by the hoppers, an ascending portion that ascends from the coin receiving portion, and a coin exit to permit coins to leave the conveyor from a location above the coin receiving portion to pass to the change exit point.

22. A coin mechanism according to claim 16, including a coin entry point and a chute to direct coins from the coin entry point to the inlet of the coin acceptor.

23. A coin mechanism according to claim 16, wherein the or each said conveyor includes a plurality of upstanding members to define receptacles to receive individual coins to be conveyed from the coin receiving portion to the exit.

24. A coin mechanism according to claim 23, wherein the upstanding members are configured so that the receptacles can receive coins of different diameters with their peripheries disposed inwardly of both longitudinal side edges of the conveyor.

25. A coin mechanism according to claim 23 wherein the upstanding members are configured so that the receptacles can receive coins of different diameters with their centres aligned in the direction of travel of the conveyor.

26. A coin mechanism according to claim 23, wherein the or each conveyor includes a plurality of segments with an individual one of the receptacles being provided on each of the segments.

27. A coin mechanism according to claim 23 wherein the upstanding members are configured to provide only two points of contact with the side edge of a coin lying with one of its major faces on the conveyor.

28. A coin mechanism according to claim 23 wherein the upstanding members include a pair of upstanding pips each for engaging the side edge of a coin lying with one of its major faces on the conveyor.

29. A coin mechanism according to claim 23 wherein the upstanding members include a pair of upstanding, converging ledges each for engaging the side edge of a coin lying with one of its major faces on the conveyor.

30. A coin mechanism according to claim 1 wherein the or each conveyor includes a toothed rack engaging with a pinion of a drive mechanism.

31. A coin mechanism comprising:
a coin entry point to receive coins;
a coin exit point;
a coin acceptor having an inlet for coins to be tested, a sensor and processing arrangement configured determine the acceptability of coins under test that enter the inlet, an coin accept path for acceptable coins and a non-accept path for non-acceptable coins;
a first coin conveyor that runs along first coin feed path from a coin receiving portion to deliver coins in succession to the inlet of the coin acceptor
a coin entry path extending from the coin entry point to the coin receiving portion of the first conveyor;
a second coin conveyor that runs along a second coin feed path from a coin receiving portion that receives coins from the non-accept path of the acceptor to the coin, to deliver coins to the coin exit point.

32. A coin mechanism according to claim 31, including a drive motor configuration to drive the first conveyor at a faster rate when no coins are exiting the first conveyor into the inlet of the acceptor, than when coins are exiting the conveyor into the inlet.

33. A coin mechanism according to claim 31 wherein the first conveyor includes a plurality of conveyor segments each configured to convey a single coin from said coin receiving portion of the first path to the inlet of the acceptor.

34. A coin mechanism according to claim 31 wherein the second conveyor includes a plurality of segments each configured to convey a plurality of coins from the coin receiving portion of the second conveyor to be delivered to the coin exit point.

35. A coin mechanism according to claim 31 including a coin return path for returning coins from the coin entry point to the coin exit point without passage along the first coin feed path, and a coin diverter device for diverting coins to pass along the coin return path when said first conveyor is not operational.

36. A coin mechanism according to claim 31 including sensors for sensing the passage of coins through the mechanism, a processor responsive to the timing of the passage of a coin past the sensors to detect a coin jam, and a jam release motor operable by the processor to release the coin from the mechanism in the event of a detected coin jam.

37. A coin mechanism according to claim 36, wherein said coin acceptor includes a coin rundown path defined between a main body of the acceptor and an door, wherein the jam release motor is operable to open the door in the event of a coin jam on the rundown path and release the coin from the acceptor.

38. A conveyor for a coin mechanism including at least one conveyor segment, side walls between which in use said conveyor segment moves longitudinally, a coin ejection outlet in one of said side walls, a coin receptacle on the segment to receive a coin, the receptacle including upstanding members disposed asymmetrically of the longitudinal centreline of the segment such at when two coins are received in coin receptacle one of them is ejected through the coin ejection outlet upon movement of the receptacle past the outlet, and the other of them remains in the receptacle.

39. A conveyor according to claim 38, wherein the upstanding members include a pair of upstanding, converging ledges each for engaging the side edge of a coin lying with one of its major faces on the segment, the converging ledges being asymmetrical and converging at a joining point to one side of the longitudinal centreline of the conveyor.

40. A coin mechanism substantially as hereinbefore described with reference to the accompanying drawings.
